(19) United States
(12) Patent Application Publication
(10) Pub. No.: US 2025/0198751 A1
(43) Pub. Date: Jun. 19, 2025

(54) MEASUREMENT MACHINE FIXTURES FOR DISPLAY SYSTEM COMPONENTS

(71) Applicant: Google LLC, Mountain View, CA (US)

(72) Inventors: Guillermo Fabian Díaz Lankenau, Santa Cruz, CA (US); Antonio Yamil Layon Halun, Mountain View, CA (US); Punit Narendra Govenji, Pleasanton, CA (US)

(21) Appl. No.: 18/977,653

(22) Filed: Dec. 11, 2024

Related U.S. Application Data
(60) Provisional application No. 63/609,804, filed on Dec. 13, 2023.

(51) Int. Cl. G01B 21/04

(52) U.S. Cl. CPC G01B 21/047

(57) ABSTRACT

According to an aspect, a device may include a fixture for use with a coordinate measurement machine (CMM), the fixture configured to support a backplate of an autostereoscopic display in a horizontal orientation during measurement of the backplate with the CMM.

### CROSS-REFERENCE TO RELATED APPLICATION

This application claims priority to U.S. Provisional Patent Application No. 63/609,804, filed on Dec. 13, 2023, entitled “Precision Inspection Supports for Display to Enable 3D Video Projection,” the disclosure of which is incorporated by reference herein in its entirety.

### BACKGROUND

A coordinate measurement machine (CMM) is a device that measures the geometry of an object. A CMM fixture is a device that holds and positions the object during measurement by the CMM. During a manufacturing process, a CMM can be used for quality control to measure components to assess whether the physical dimensions of the component are within specified tolerances.

### SUMMARY

This disclosure relates to metrology systems and in particular coordinate measuring machine (CMM) fixtures for holding and positioning sheet material components of display systems. Aspects of the present disclosure include CMM fixtures that are designed and configured to hold and position display system sheet metal backplates for precise and repeatable measurements of the backplate without interfering with a shape of the backplate in a way that would impair the accuracy of the measurement.

In some aspects, the techniques described herein relate to a coordinate measuring machine (CMM) fixture for a backplate of an autostereoscopic display, wherein the backplate includes a plurality of mounting points, the CMM fixture including: a fixture table; and a plurality of vertical support members extending from the fixture table configured to support the backplate in a horizontal orientation above the fixture table; wherein the plurality of vertical support members include a pivoting multi-contact vertical support member that includes a horizontal pivot arm pivotally coupled at a pivot point to a support member, wherein the horizontal pivot arm includes a first contact point and a second contact point located on opposite sides of the pivot point, wherein the first contact point and second contact point are configured to make contact with locations on the backplate proximate corresponding ones of the plurality of mounting points.

In some aspects, the techniques described herein relate to a CMM fixture, further including: a plurality of horizontal guide members that include first and second guide members positioned to make contact with a first side of the backplate and a third guide member positioned make contact with a second side of the backplate; wherein when the backplate is positioned on the plurality of vertical support members the first and second sides of the backplate contact the plurality of horizontal guide members.

In some aspects, the techniques described herein relate to a CMM fixture, wherein at least one of the plurality of horizontal guide members includes multi-state magnetic portion configured to selectively magnetically couple to the backplate, wherein the CMM fixture further includes a magnet control element for selectively activating the multi-state magnetic portion.

In some aspects, the techniques described herein relate to a CMM fixture, further including at least one contact sensor operably coupled to at least one of the plurality of horizontal guide members, wherein the at least one contact sensor generates a contact signal that indicates whether the backplate is in contact with the at least one horizontal guide member.

In some aspects, the techniques described herein relate to a CMM fixture, wherein the contact sensor detects a magnetic field generated by the multi-state magnetic portion.

In some aspects, the techniques described herein relate to a coordinate measuring machine (CMM) fixture for a backplate of an autostereoscopic display, wherein the backplate includes a plurality of mounting points, the CMM fixture including: a fixture table; a plurality of vertical support members extending from the fixture table for supporting the backplate in a horizontal orientation above the fixture table, the plurality of vertical support members including multi-state magnetic portions to selectively magnetically couple to the backplate; and a magnet control element for selectively activating the multi-state magnetic portions; wherein the plurality of vertical support members have contact points that are positioned to make contact with locations on the backplate proximate the plurality of mounting points.

In some aspects, the techniques described herein relate to a CMM fixture, wherein the plurality of contact points are each rigidly and non-moveably coupled to the fixture table.

In some aspects, the techniques described herein relate to a CMM fixture, wherein a number of the plurality of vertical support members is the same as a number of the plurality of mounting points.

In some aspects, the techniques described herein relate to a CMM fixture, further including a plurality of horizontal guide members for orienting and positioning the backplate with respect to the CMM fixture.

The accompanying drawings and the description below set forth the details of one or more implementations. Other features will be apparent from the description, drawings, and claims.

### BRIEF DESCRIPTION OF THE DRA WINGS

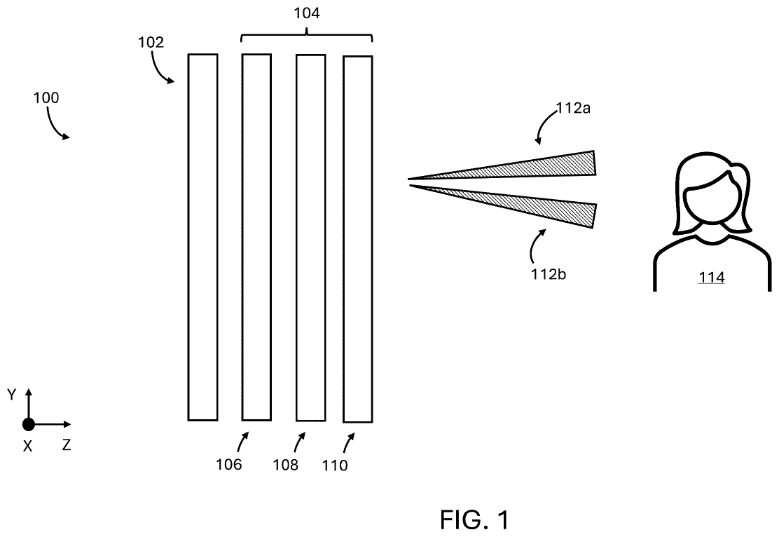

FIG. 1 illustrates an example autostereoscopic display system that CMM fixtures of the present disclosure may be designed to support for inspection during a manufacturing process.

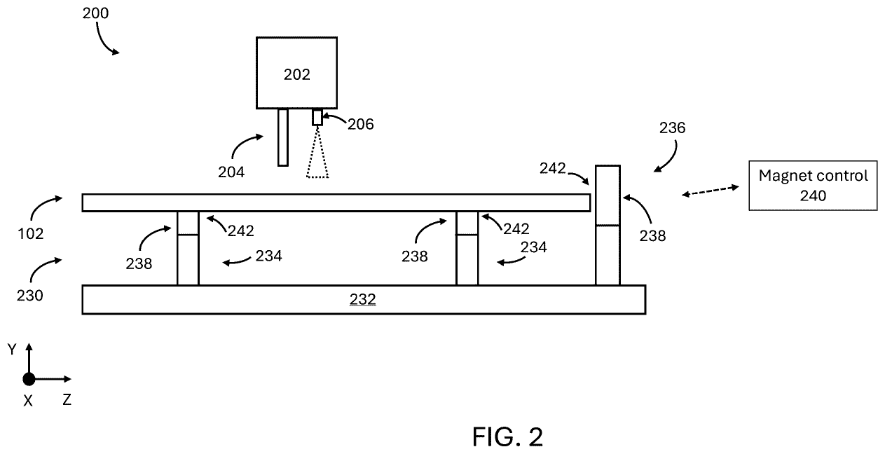

FIG. 2 is a side view of an example inspection system.

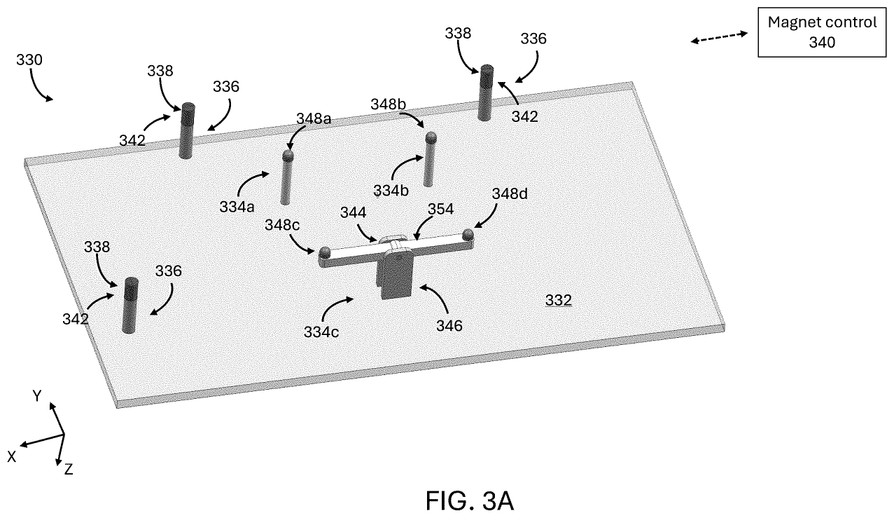

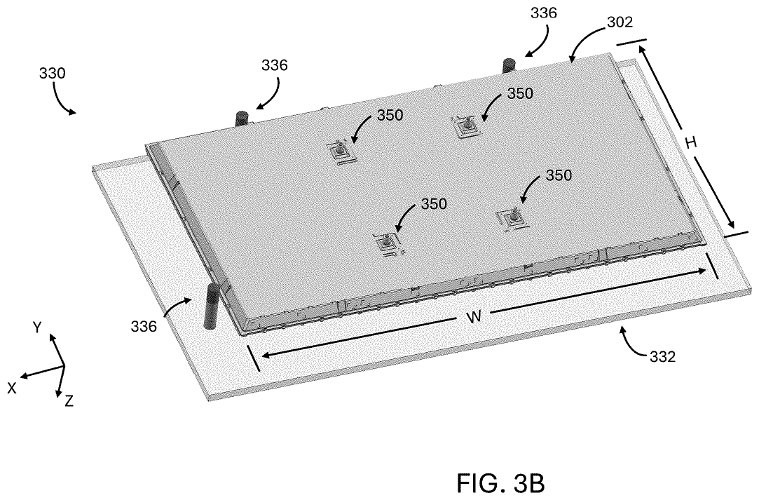

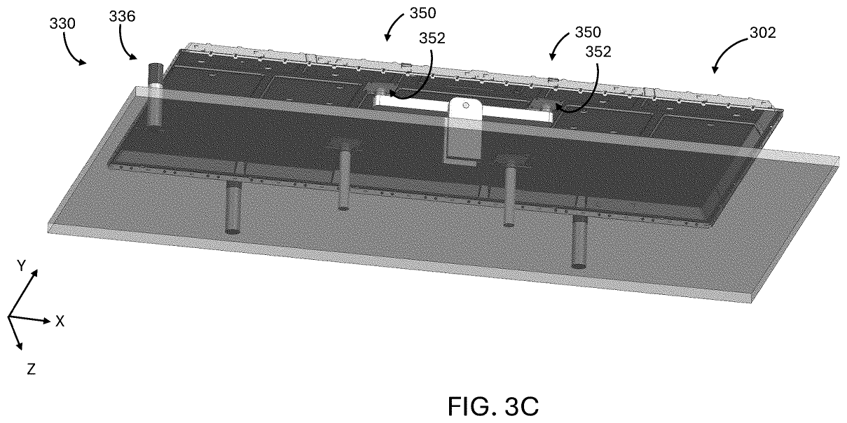

FIG. 3A is a top perspective view of an example CMM fixture.

FIG. 3B is a top perspective view of the example CMM fixture of FIG. 3A showing an example backplate positioned on the CMM fixture.

FIG. 3C is a bottom perspective view of the CMM fixture and backplate of FIG. 3B.

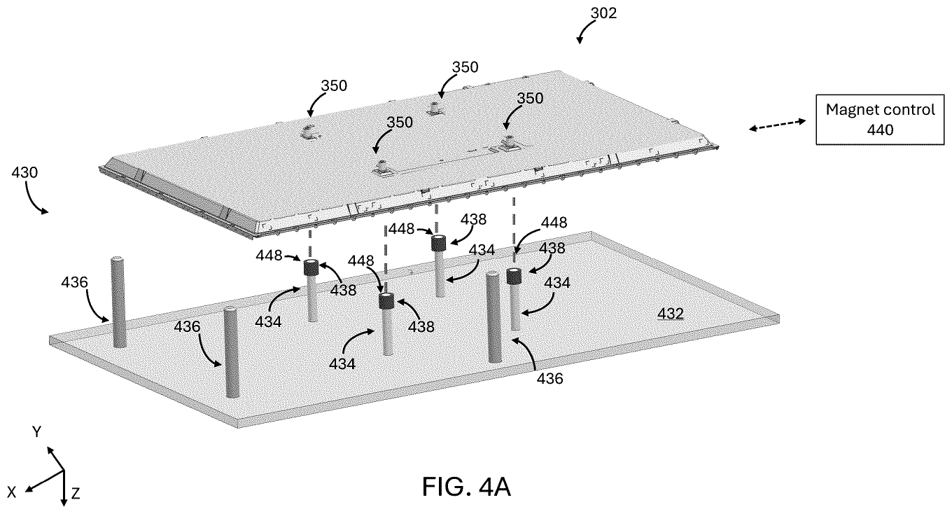

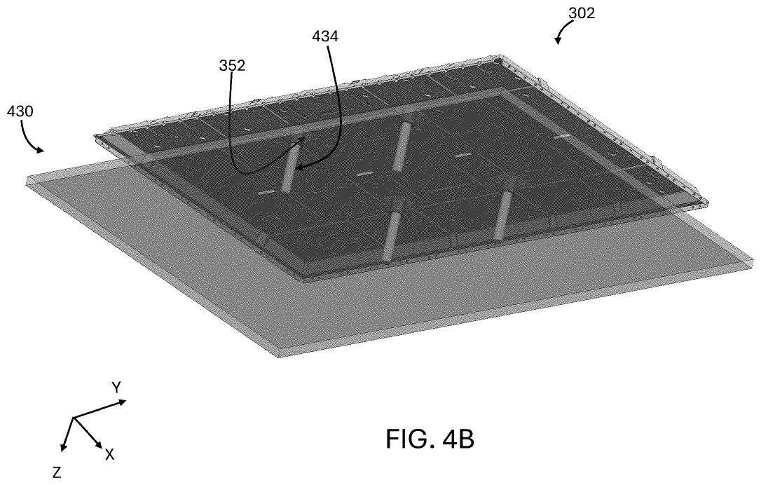

FIG. 4A is a top perspective view of an example CMM fixture and an example backplate positioned above the CMM fixture.

FIG. 4B is a bottom perspective view of the CMM fixture and backplate of FIG. 4A with the backplate positioned on the CMM fixture.

### DETAILED DESCRIPTION

This disclosure relates to CMM fixtures for holding and positioning sheet material components of display systems for inspection of the components. Display systems, such as autostereoscopic display systems, typically include a sheet metal backplate that forms a rear portion of the display. The metal backplate of a display system supports optical elements of the display and also acts as a mounting interface for mounting the display to an external support such as a wall. In backlit displays, the backplate also acts as the substrate for backlight optical elements such as arrays of light emitting elements.

CMMs can be used for quality control during the manufacturing of autostereoscopic displays. Autostereoscopic displays are electronic display screens that provide a glasses-free three-dimensional (3D) viewing experience. The perception of 3D depth is achieved by displaying a pair of stereoscopic images. One of the images is presented to one of the viewer's eyes and the other is presented to the other one of the viewer's eyes. The optical systems that are used to generate the stereoscopic images typically require a higher level of precision than some other types of display systems.

The higher level of precision presents a manufacturing challenge, particularly for larger displays. For example, in the case of autostereoscopic displays, the optical systems that are used to generate the pairs of stereoscopic images require a high level of dimensional precision, including flatness. If the optical layers are not sufficiently flat, the pairs of stereoscopic images will not be transmitted in the intended directions, which can cause image distortions and degrade image quality, such as causing undesirable crosstalk between the two images.

The stiffness of the sheet metal backplate of a display is typically similar to the stiffness of the layers attached to the backplate. Therefore, an unintended curvature or deformation in the backplate due to, for example, a manufacturing defect, can cause a corresponding deformation in the optical layers of the display which can degrade image quality.

There is, therefore, a need to inspect a display screen backplate during a manufacturing process to confirm it is within required dimensional tolerances, however, inspecting sheet metal plates for high levels of dimensional precision is challenging. A large sheet metal backplate is relatively flexible due to the size of the metal backplate relative to the thickness of the sheet metal material. Existing CMM fixtures can have the undesirable effect of bending or over-constraining the backplate when the backplate is mounted in the fixture, thereby improperly influencing the shape of the backplate and preventing an accurate measurement. The ability to inspect a large metal backplate component for tight dimensional tolerances, such as flatness is, therefore, a technical problem.

In at least one technical solution, a CMM fixture is provided that is designed and configured to hold and position a metal backplate for a display in such a way that it is not over-constrained and does not interfere with the natural shape of the backplate to allow for accurate and repeatable measurements. At least one technical effect of the foregoing technical solution is a greater ability to perform quality control and inspection during a display system manufacturing process to ensure out of tolerance metal backplates are not used in the manufacturing process.

FIG. 1 illustrates an example autostereoscopic display system 100 that CMM fixtures of the present disclosure may be designed to support for inspection during a manufacturing process. Autostereoscopic display system 100 includes a backplate 102 and an optical stack 104 coupled to a front side of the backplate for generating stereoscopic images 112. Optical stack 104 can include any components now used or later developed for generating stereoscopic images. By way of example, optical stack 104 may include a selectively-transmissive display pixel matrix 106 (such as a liquid crystal (LC) display), at least one stereoscopic image layer 108, which may be positioned on either side of selectively-transmissive display pixel matrix 106, and a cover glass layer 110.

Selectively-transmissive display pixel matrix 106 may include any components known in the art of liquid crystal displays, such as a polarizing filter layer, electrode layers, a liquid crystal material layer, and polarizer layers. Other transmissive display technologies other than liquid crystal displays may also be used. The at least one stereoscopic image layer 108 may include an array of lenticular lenses and/or a parallax barrier, and/or other optical layers for generating stereoscopic images 112. The backplate 102 may include a main body of sheet metal material and also include any backlight components known in the art. For example, a matrix or other two-dimensional array of backlight pixels such as white-light LEDs may be disposed on an interior surface of the backplate 102. In some examples, other optical layers, such as one or more of a parallax barrier, lenticular lens array, and/or a diffuser layer, among others, may also be coupled to backplate 102, for example to form a steerable backlight unit.

Autostereoscopic display system 100 is configured to display pairs of stereoscopic images 112a, 112b, with a first image 112a directed to one eye of a user 114 and the second image 112b directed to the other eye of the user 114. Successful operation of the autostereoscopic display system 100 requires the layers of the optical stack 104 to be extremely flat in the X-Y plane, for example equal to or less than +/−approximately 3 mm, and in some examples, equal to or less than +/−approximately 2 mm, and in some examples, equal to or less than +/−approximately 1 mm. If the optical stack 104 is not sufficiently flat, the stereoscopic images 112 may not be emitted in the correct direction which may prevent them from creating a perception of 3D depth. The backplate 102 can have a significant influence on the flatness of the optical stack 104, particularly as the size of the display increases. The layers of the selectively-transmissive display pixel matrix 106 and the at least one stereoscopic image layer 108 are relatively more flexible and compliant as compared to backplate 102. The cover glass layer 110 is generally more rigid than the selectively-transmissive display pixel matrix 106 and the at least one stereoscopic image layer 108 layers and has a similar stiffness as backplate 102. Therefore, an unintended curvature in the backplate 102 can cause a corresponding curvature in the optical stack 104, thereby impairing the directionality of the stereoscopic images 112.

FIG. 2 illustrates an example inspection system 200 for inspecting a metal backplate, such as backplate 102 of an autostereoscopic display, such as autostereoscopic display system 100. Example inspection system 200 includes a coordinate measurement machine, CMM 202, that takes measurements of a workpiece, such as backplate 102, and a CMM fixture 230 that supports the workpiece in a horizontal orientation. The CMM fixture 230 may be designed and configured to maintain the backplate 102 in a static position during measurements, to hold the backplate 102 without deforming the backplate with the supports of the CMM fixture 230, and hold the backplate in such a way that any features of interest for measurement and inspection are accessible for measurement by the CMM 202.

CMM 202 may be any of a variety of types of CMMs, including contact and/or non-contact CMM (the latter sometimes also referred to as an optical measurement machine or vision measurement machine) and have corresponding contact sensing elements 204 and/or non-contact optical sensing elements 206. CMM 202 may be, for example, a bridge-type, gantry, or horizontal arm CMM.

Example CMM fixture 230 includes a fixture table 232 and a plurality of vertical support members 234 extending from the fixture table in the form of, for example, standoffs, for supporting a workpiece, such as backplate 102 above the fixture table 232 at a predetermined location above the fixture table 232. In some examples CMM fixture 230 may also include one or more horizontal guide members 236 for defining a specific orientation and X-Y position of the backplate 102 with respect to the CMM fixture 230. In some examples, one or more of the plurality of vertical support members 234 and/or one or more of the horizontal guide members 236 may include a multi-state magnetic portion 238 for selectively magnetically coupling a workpiece, such as backplate 102, to the CMM fixture 230.

Inspection system 200 may also include a magnet control element 240 for remotely selecting a magnetic state of each of the multi-state magnetic portions 238. In an example, each of the multi-state magnetic portions 238 may have a first state, in which the magnetic portion emits a magnetic field that magnetically couples to an adjacent ferromagnetic element and a second state, in which the magnetic field is changed or eliminated to change or remove the magnetic coupling. During use of inspection system 200, the multi-state magnetic portions 238 can initially be in the second state so that a workpiece such as backplate 102 can be freely adjusted on the CMM fixture 230. Once a desired position is achieved, magnet control element 240 may be selected to activate the multi-state magnetic portions 238 to magnetically couple the backplate 102 to the CMM fixture 230 to secure the backplate 102 in place during the inspection process.

In some implementations, inspection system 200 may also include one or more contact sensors 242 that are operably coupled to one or more contact points where the CMM fixture 230 makes contact with a workpiece such as backplate 102. The one or more contact sensors 242 may generate a signal that is representative of whether a workpiece such as backplate 102 is in contact with the CMM fixture 230 at a given contact point. For example, one or more contact sensors 242 may indicate whether the backplate 102 is in contact with the one or more horizontal guide members 236 and/or one or more of the plurality of vertical support members 234. In some examples, the one or more contact sensors 242 may detect a change in a magnetic field generated by the multi-state magnetic portions 238 due to contact between the backplate 102 and the multi-state magnetic portions 238. For example, the one or more contact sensors 242 may be a hall effect or capacitance sensor that is configured to detect a shunting of the magnetic field generated by the multi-state magnetic portions 238 by the backplate 102 when the backplate 102 is in contact with the multi-state magnetic portions 238. In some examples, the one or more contact sensors 242 may include other types of sensors, such as other types of proximity sensors or physical contact sensors such as contact switches. During use, an inspection process can be paused or repeated if one of the one or more contact sensors 242 indicate the backplate 102 is not in contact with a corresponding contact point, thereby indicating the backplate 102 was not in the correct position or orientation during the inspection process.

Contact forces associated with a measurement process performed by CMM 202 may be very small or substantially zero, and in some examples, CMM 202 contact forces are less than a weight of the backplate 102. Accordingly, a separation force of the multi-state magnetic portions 238 can be relatively small. For example, a separation force of the multi-state magnetic portions 238 may be less than approximately 50 N, and in some examples, less than approximately 50 N, and in some examples, less than approximately 25 N, and in some examples, less than approximately 10 N, and in some examples, less than approximately 5 N.

FIGS. 3A-3C illustrate an example implementation of a CMM fixture 330. FIG. 3A illustrates a top perspective view of CMM fixture 330 and FIG. 3B illustrates a top perspective view of the CMM fixture 330 with a backplate 302 positioned on the CMM fixture 330. FIG. 3C illustrates a bottom perspective view of the CMM fixture 330 with the backplate 302 positioned on the CMM fixture 330 and with the CMM fixture 330 shown in partially transparent form to better illustrate the arrangement. The CMM fixture 330 may be designed and configured to maintain the backplate 302 in a static position during measurements, to hold the backplate without deforming the backplate with the supports of the CMM fixture 330, and hold the backplate in such a way that any features of interest for measurement and inspection are accessible for measurement by a CMM.

Example CMM fixture 330 includes a fixture table 332 and a plurality of vertical support members 334 in the form of, for example, standoffs, for supporting a workpiece, such as backplate 302 above the fixture table 332 at a predetermined location above the fixture table 332. In some examples CMM fixture 330 may also include one or more horizontal guide members 336 for defining a specific orientation and X-Y position of the backplate 102 with respect to the CMM fixture 330. In the illustrated example, the horizontal guide members 336 include multi-state magnetic portions 338 for selectively magnetically coupling a workpiece to the CMM fixture 330. CMM fixture 330 may also include a magnet control element 340 for remotely selecting a magnetic state of each of the multi-state magnetic portions 338. In an example, each of the multi-state magnetic portions 338 may have a first state, in which the magnetic portion emits a magnetic field that magnetically couples to an adjacent ferromagnetic element and a second state, in which the magnetic field is changed or otherwise eliminated to remove the magnetic coupling. During use of CMM fixture 330, the multi-state magnetic portions 338 can initially be in the second state so that a workpiece can be freely adjusted on the CMM fixture 330. Once a desired position is achieved, magnet control element 340 may be selected to activate the multi-state magnetic portions 338 to magnetically couple the workpiece to the CMM fixture 330 to secure the workpiece in place during a measurement process. In an example, a separation force generated by each of the multi-state magnetic portions 338 may be between approximately 15 N and approximately 25 N.

In the illustrated example, the plurality of vertical support members 334 include a pivoting multi-contact vertical support member 334c that includes a horizontal pivot arm 354 pivotally coupled at a pivot point 344 to a support member 346, wherein the horizontal pivot arm 354 includes a first contact point 348c and a second contact point 348d located on opposite sides of the pivot point 344. The plurality of vertical support members 334 also include a first vertical support member 334a that includes a contact point 348a and a second vertical support member 334b that includes a contact point 348b. In the illustrated example, the contact points 348 of the plurality of vertical support members 334 are spherical contact points.

FIGS. 3B and 3C show CMM fixture 330 with a backplate 302 positioned on the CMM fixture 330 for measurement. An interior surface of the backplate 302 is in contact with the contact points 348 with the opposite exterior surface of the backplate facing upward for dimensional inspection by a CMM such as CMM 202.

Backplate 302 may have some or all of the characteristics as backplate 102 described above and may be a backplate for an autostereoscopic display system such as autostereoscopic display system 100. In some examples, backplate 302 may be part of a relatively large autostereoscopic display system 100, for example, a width, W, of the backplate 302 may be between approximately 1 m and approximately 2 m, and in some examples, between approximately 1 m and approximately 1.5 m. A height, H, of backplate 302 may be between approximately 0.5 and approximately 1, and in some examples between approximately 0.5 and approximately 0.8. A diagonal dimension of the backplate may be between approximately 1 m and 5 m, and in some examples, between approximately 1 m and 2 m, and in some examples, a diagonal dimension of approximately 1.65 m. The example backplate 302 may be formed from sheet metal having a thickness between approximately 1 mm and approximately 2 mm and in some examples between approximately 1 mm and approximately 1.5 mm.

Example backplate 302 has a plurality of mounting points 350 and in the illustrated example, the mounting points 350 include four VESA mounts (where VESA stands for the Video Electronics Standards Association, which defines standards for mounting displays). As best seen in FIG. 3C, the plurality of mounting points 350 are reinforced on the interior surface of the backplate 302 by reinforcement plates 352. In the illustrated example the plurality of vertical support members 334 are positioned and dimensioned so that the contact points 348 of the plurality of vertical support members 334 can be aligned with and make contact with the reinforcement plates 352. This can be beneficial because the reinforcement plates 352 are a more durable location for supporting the backplate 302 and ensure the contact points 348 do not come into contact with more sensitive thin sections of metal that could be damaged by the weight of the backplate 302 resting on the contact points 348.

The arrangement of the plurality of vertical support members 334 including the pivoting multi-contact vertical support member 334c can be beneficial for applications requiring precise flatness measurements of large and flexible sheet metal components such as backplate 302. For example, the plurality of vertical support members 334 do not over-constrain the backplate 302 or influence the shape of the backplate 302 in a way that would impair the measurement results. For example, an alternative CMM fixture that was over-constrained may bend the backplate 302 into a flat shape during the process of securing the backplate 302 to the fixture, thereby masking or hiding an out of tolerance flatness. By contrast, the plurality of vertical support members 334 provide a minimal number of contact points 348 while still making contact with reinforced sections (reinforcement plates 352) of the backplate 302. The plurality of vertical support members 334 are configured to position the backplate 302 in a desired plane. While only three points are required to define a plane, as noted above, it can be beneficial to provide contact points 348 at reinforcement plates 352, resulting in four points of contact rather than three because only three support points may provide insufficient support, particularly as the size of the display screen increases, which could result in excessive deformation of the backplate while being supported in the fixture.

Pivoting multi-contact vertical support member 334c provides for a balanced support while allowing for four points of contact rather than three so that a balanced contact can be made at the four reinforcement plates 352. The horizontal pivot arm 354 in the form of a pivoted rigid bar between two of the contact points 348 effectively provides the positional repeatability of only three contact points while still maintaining the structural integrity provided by four contact points. In the illustrated example a number of the contact points 348, here four, corresponds to a number of mounting points 350 on the backplate 302 and the CMM fixture 330 only contacts the front side of the backplate 302 at the four locations proximate the plurality of mounting points 350, e.g., it only contacts the front side of backplate 302 at the reinforcement plates 352.

CMM fixture 330 includes a plurality of the one or more horizontal guide members 336, with two positioned along the long side of the backplate 302 and one positioned along the short side of the backplate. In other examples more or fewer horizontal guide members 336 may be used and in some examples two of the horizontal guide members may be positioned along a short side of the backplate and only one positioned along the long side of the backplate. The one or more horizontal guide members 336 may be used to ensure that each backplate 302 is secured to the CMM fixture 330 in a consistent position and orientation for measurement. The multi-state magnetic portions 338 may be used to secure the backplate 302 to the CMM fixture 330 after the backplate 302 is in the correct position. CMM fixture 330 may also include a plurality of contact sensors 342 which may have the same or similar configuration as the one or more contact sensors 242 (FIG. 2). One or more of the plurality of contact sensors 342 may be operably coupled to corresponding ones of the multi-state magnetic portions 338 to indicate whether the backplate 302 is in contact with the one or more horizontal guide members 336 during a measurement process. In the illustrated example the contact points 348 of the plurality of vertical support members 334 do not magnetically couple to the backplate 302. The spherical or other low surface area contact of the contact points 348 provides for a relatively light and low resistance contact between the plurality of vertical support members 334 and the backplate 302. In some examples, a relatively weak magnetic coupling at the one or more horizontal guide members 336 is sufficient for a CMM measurement process because the CMM measurement process involves very light or in some cases no contact between the CMM and the backplate 302. In some examples, the multi-state magnetic portions 338 are omitted.

FIGS. 4A and 4B illustrates an example implementation of a CMM fixture 430. FIG. 4A is a top perspective view of the CMM fixture 430 and shows the CMM fixture 430 with the same backplate 302 as is described and illustrated above. FIG. 4B is a bottom perspective view of the CMM fixture 430 with the table shown as partially transparent to illustrate the alignment of the fixture table contact points with the backplate.

Example CMM fixture 430 includes a fixture table 432 and a plurality of vertical support members 434 in the form of, for example, standoffs, for supporting a workpiece, such as backplate 302, above the fixture table 432 at a predetermined location above the fixture table 432. FIG. 4A shows backplate 302 above the CMM fixture 430 with dotted lines indicating a direction of movement for placing the backplate 302 onto the CMM fixture 430 in a horizontal orientation for measurement by a CMM such as CMM 202 (FIG. 2). The CMM fixture 430 may be designed and configured to maintain the backplate 302 in a static position during measurements, to hold the backplate without deforming the backplate with the supports of the CMM fixture 430, and hold the backplate in such a way that any features of interest for measurement and inspection are accessible for measurement by a CMM.

As shown in FIG. 4B, the plurality of vertical support members 434 may be positioned and dimensioned to align with the reinforcement plates 352 on the front side of the backplate 302 (only one of each labeled in FIG. 4B). The plurality of vertical support members 434 may include multi-state magnetic portions 438 for selectively magnetically coupling a workpiece to the CMM fixture 430. In the illustrated example the multi-state magnetic portions 438 have a cylindrical outer shape that defines a contact point 448 in the form of a flat surface with a circular outer shape at an end of the corresponding vertical support member 434 that makes contact with a corresponding reinforcement plate 352 of the backplate 302. In an example, a separation force generated by each of the multi-state magnetic portions 438 may be between approximately 5 N and approximately 10 N.

Unlike the plurality of vertical support members 334 of CMM fixture 330 (FIGS. 3A-3C), which include a pivoting multi-contact vertical support member 334c, the plurality of contact points 448 are each rigidly and non-moveably coupled to the fixture table 432. The magnetic coupling of the backplate 302 to the plurality of vertical support members 434 is similar to how the backplate 302 will be coupled to a support structure during use. For example, the backplate 302 may be coupled to the CMM fixture 430 at the contact points 448 at locations on the backplate 302 proximate the plurality of mounting points 350. In the illustrated example a number of the plurality of vertical support members 434, here four, is the same as a number of mounting points 350 on the backplate 302. In some examples the CMM fixture 430 only contacts the front side of the backplate 302 at the four locations proximate the four mounting points 350, e.g., it only contacts the front side of backplate 302 at the reinforcement plates 352.

The CMM fixture 430 may also include a magnet control element 440 for remotely selecting a magnetic state of each of the multi-state magnetic portions 438. In an example, each of the multi-state magnetic portions 438 may have a first state, in which the magnetic portion emits a magnetic field that magnetically couples to an adjacent ferromagnetic element and a second state, in which the magnetic field is changed or otherwise eliminated to remove the magnetic coupling. During use of CMM fixture 430, the multi-state magnetic portions 438 can initially be in the second state so that a workpiece can be freely adjusted on the CMM fixture 430. Once a desired position is achieved, magnet control element 440 may be selected to activate the multi-state magnetic portions 438 to magnetically couple the workpiece to the CMM fixture 430 to secure the workpiece in place during a measurement process.

In some examples CMM fixture 430 may also include one or more horizontal guide members 436 for defining a specific orientation and X-Y position of the backplate 302 with respect to the CMM fixture 430 and to aid with positioning the backplate 302 on the plurality of vertical support members 434. In some examples, the one or more horizontal guide members 436 do not include magnetic portions, while in other examples, the plurality of vertical support members 434 may include magnetic portions for securing the backplate 302 in place.

In some examples CMM fixture 430 may also include one or more contact sensors (not illustrated) which may have the same or similar configuration as the one or more contact sensors 242 and/or 342 for providing an indication of whether the backplate 302 is in contact with the one or more of the plurality of vertical support members 434 and/or horizontal guide members 436 during a measurement process.

In this specification and the appended claims, the singular forms “a,” “an” and “the” do not exclude the plural reference unless the context clearly dictates otherwise. Further, conjunctions such as “and,” “or,” and “and/or” are inclusive unless the context clearly dictates otherwise. For example, “A and/or B” includes A alone, B alone, and A with B. Further, connecting lines or connectors shown in the various figures presented are intended to represent example functional relationships and/or physical or logical couplings between the various elements. Many alternative or additional functional relationships, physical connections or logical connections may be present in a practical device. Moreover, no item or component is essential to the practice of the implementations disclosed herein unless the element is specifically described as “essential” or “critical”.

Terms such as, but not limited to, approximately, substantially, generally, etc. are used herein to indicate that a precise value or range thereof is not required and need not be specified. As used herein, the terms discussed above will have ready and instant meaning to one of ordinary skill in the art.

Moreover, use of terms such as up, down, top, bottom, side, end, front, back, etc. herein are used with reference to a currently considered or illustrated orientation. If they are considered with respect to another orientation, such terms must be correspondingly modified.

Further, in this specification and the appended claims, the singular forms “a,” “an” and “the” do not exclude the plural reference unless the context clearly dictates otherwise. Moreover, conjunctions such as “and,” “or,” and “and/or” are inclusive unless the context clearly dictates otherwise. For example, “A and/or B” includes A alone, B alone, and A with B.

Although certain example methods, apparatuses and articles of manufacture have been described herein, the scope of coverage of this patent is not limited thereto. It is to be understood that terminology employed herein is for the purpose of describing aspects and is not intended to be limiting. On the contrary, this patent covers all methods, apparatus and articles of manufacture fairly falling within the scope of the claims of this patent.

What is claimed is:

1. A coordinate measuring machine (CMM) fixture for a backplate of an autostereoscopic display, wherein the backplate includes a plurality of mounting points, the CMM fixture comprising:
a fixture table; and
a plurality of vertical support members extending from the fixture table configured to support the backplate in a horizontal orientation above the fixture table;
wherein the plurality of vertical support members include a pivoting multi-contact vertical support member that includes a horizontal pivot arm pivotally coupled at a pivot point to a support member, wherein the horizontal pivot arm includes a first contact point and a second contact point located on opposite sides of the pivot point, wherein the first contact point and second contact point are configured to make contact with locations on the backplate proximate corresponding ones of the plurality of mounting points.

2. The CMM fixture of claim 1, further comprising:
a plurality of horizontal guide members that include first and second guide members positioned to make contact with a first side of the backplate and a third guide member positioned make contact with a second side of the backplate;
wherein when the backplate is positioned on the plurality of vertical support members the first and second sides of the backplate contact the plurality of horizontal guide members.

3. The CMM fixture of claim 2, wherein at least one of the plurality of horizontal guide members includes multi-state magnetic portion configured to selectively magnetically couple to the backplate, wherein the CMM fixture further comprises a magnet control element for selectively activating the multi-state magnetic portion.

4. The CMM fixture of claim 3, further comprising at least one contact sensor operably coupled to at least one of the plurality of horizontal guide members, wherein the at least one contact sensor generates a contact signal that indicates whether the backplate is in contact with the at least one horizontal guide member.

5. The CMM fixture of claim 4, wherein the contact sensor detects a magnetic field generated by the multi-state magnetic portion.

6. A coordinate measuring machine (CMM) fixture for a backplate of an autostereoscopic display, wherein the backplate includes a plurality of mounting points, the CMM fixture comprising:
a fixture table;
a plurality of vertical support members extending from the fixture table for supporting the backplate in a horizontal orientation above the fixture table, the plurality of vertical support members including multi-state magnetic portions to selectively magnetically couple to the backplate; and
a magnet control element for selectively activating the multi-state magnetic portions;
wherein the plurality of vertical support members have contact points that are positioned to make contact with locations on the backplate proximate the plurality of mounting points.

7. The CMM fixture of claim 6, wherein the plurality of contact points are each rigidly and non-moveably coupled to the fixture table.

8. The CMM fixture of claim 6, wherein a number of the plurality of vertical support members is the same as a number of the plurality of mounting points.

9. The CMM fixture of claim 6, further comprising a plurality of horizontal guide members for orienting and positioning the backplate with respect to the CMM fixture.
